(19) United States
(12) Patent Application Publication
(10) Pub. No.: US 2014/0251644 A1
(43) Pub. Date: Sep. 11, 2014

(54) FIRE RETARDING APPLIANCE AND SYSTEM

(71) Applicants: Benjamin Adair Munro, Auckland (NZ); Kristian Hugh Darcy Slack, New Plymouth (NZ); John Kinnear Terry, Wellington (NZ)

(72) Inventors: Benjamin Adair Munro, Auckland (NZ); Kristian Hugh Darcy Slack, New Plymouth (NZ); John Kinnear Terry, Wellington (NZ)

(73) Assignee: Sensorjet Holdings Limited, Auckland (NZ)

(21) Appl. No.: 14/350,346

(22) PCT Filed: Oct. 3, 2012
(86) PCT No.: PCT/NZ2012/000177

§ 371 Date: Apr. 7, 2014

(30) Foreign Application Priority Data
Oct. 7, 2011 (NZ) 595648

(51) Int. Cl. A62C 3/00

(52) U.S. Cl. CPC A62C 3/006
USPC 169/61

(57) ABSTRACT

An appliance having the capability to assist in retarding a fire external to the appliance. One or more nozzle may be incorporated within the appliance or provided externally to provide a fluid mist. The main appliance pump or a separate pump may provide pressurised fluid to the one or more nozzles or a pressurised supply to the appliance may be used directly. A control circuit for controlling one or more pumps and or valves may be incorporated in the main appliance control circuitry or provided separately. One or more fire detection sensors may be provided within or external to the appliance and may communicate with the control circuit via a wireless signal, over power lines, via a sound signal or over communication lines. Where a nozzle is incorporated into an appliance it may be located on a surface of an appliance that is exposed when the appliance is installed. A pop-out nozzle may be provided behind a burst panel. The appliance may also include an internal fire suppressing system. The appliance may be a cleaning appliance (such as a washing machine, dishwasher etc. with an internal pump), a waste disposer, a coffee maker, a plumbed fridge, an ice maker, a boiler or like appliance. Where the appliance is a waste disposer a pump may be included driven by the waste disposer motor. A popup nozzle may be included in the waste disposer that extends out of the waste disposer when pressurised fluid is provided thereto. A control circuit of the waste disposer may control the supply of fluid to the waste disposer during operation of the waste disposer. A nozzle located remote from the waste disposer may also be plumbed to the pump of the waste disposer.

### FIELD OF THE INVENTION

The present invention relates to an appliance having capability to assist in retarding a fire external to the appliance and a system incorporating such appliances. More particularly, although not exclusively, the invention relates to an appliance that utilises components used for its normal operation for retarding fires.

### BACKGROUND TO THE INVENTION

A number of systems for suppressing fires initiated in a kitchen have been developed and produced. The most common systems are manually operated, hand-held, fire extinguishers and plumbed-in sprinkler systems. The hand-held extinguishers require manual actuation and operation, and have a finite volume of suppressant. Sprinkler systems require significant plumbing and installation works and are consequently difficult to retrofit and expensive.

The invention addresses the problems of the existing approaches to suppressing fires in a kitchen by providing an automatic device that is not limited by volume of suppressant and requires no modification to existing plumbed infrastructure.

U.S. Pat. No. 4,930,579 discloses the use of a sprinkler head on a hose attached to a spigot for a boiler—the system is not integrated into an appliance and is connected directly and solely to the water supply.

CA2164649 discloses a fire extinguisher incorporated into a stove with multiple nozzles.

U.S. Pat. No. 6,648,077 discloses a fire extinguisher sprinkler head adapted to fit onto existing pipework. The system is not integrated.

U.S. Pat. No. 7,013,577 discloses an internal sprinkler system for an industrial clothes dryer.

U.S. Pat. No. 7,231,988 discloses an internal sprinkler system for a water-conducting domestic appliance.

US2009/0159301 describes an internal fire suppression system for an appliance such as a clothes dryer.

U.S. Pat. No. 3,866,687 describes a system for extinguishing fires comprising a number of nozzles mounted on a tank containing extinguishant under pressure.

EP1844819 describes a transportable room fire extinguisher column comprising a tank, power supply and nozzles.

U.S. Pat. No. 7,878,258 describes a portable fire suppression installation comprising a tank, pump and misting nozzles.

WO2008041867 discloses a fire suppression apparatus adapted for connection to a water supply for a faucet.

WO2010082853 discloses a fire suppression apparatus and/or cooking appliance with a fire suppression apparatus adapted for installation or installed at a location on or proximate the cooking appliance.

None of these documents discloses an appliance that incorporates an external fire suppression capability using the existing appliance functionality.

It is an object of the invention to provide an appliance having external fire suppression capability using existing appliance functionality or to at least provide the public with a useful choice.

### SUMMARY OF THE INVENTION

According to a first aspect there is provided an appliance having capability to assist in retarding a fire external to the appliance including:
a. a pump having a pump inlet connectable to a fluid supply and a pump outlet;
b. a nozzle conduit for supplying pressurised fluid from the pump outlet to a nozzle positioned so as to generate a mist external to the appliance when supplied with pressurised fluid; and
c. a control circuit which operates in a fire hazard mode to control the pump to operate when a fire hazard is detected.

The pump may be a specific pump for supplying pressurised fluid to the nozzle conduit or one pump may be utilised for the normal appliance function as well as for supplying pressurised fluid to the nozzle conduit. A flow control arrangement may be provided which normally connects the pump outlet to the normal appliance function and connects the pump outlet to the nozzle conduit when a fire hazard is detected. This may be in the form of a multi-port valve or utilise a number of solenoid valves or other suitable arrangement.

The nozzle conduit may be directly connected to a nozzle incorporated into the appliance or it may be connected to a nozzle outlet, such as a snap-fit coupling, enabling an external nozzle to be connected.

Where a nozzle is incorporated into an appliance it may be located on a surface of an appliance that is exposed when the appliance is installed. A pop-out nozzle may be provided behind a burst panel.

The control circuit may control the normal appliance function as well as operation in the fire hazard mode. The control circuit may be responsive to an external fire detection sensor or a fire detection sensor may be integrated into the appliance. An external fire detection circuit may communicate with the control circuit via a wireless signal, over power lines, via a sound signal or over communication lines.

The appliance may be a cleaning appliance (such as a washing machine, dishwasher etc. with an internal pump), a waste disposer, a coffee maker, a plumbed fridge, a boiler or like appliance.

Where the appliance is a waste disposer a pump may be included driven by the waste disposer motor. A popup nozzle may be included in the waste disposer that extends out of the waste disposer when pressurised fluid is provided thereto. A control circuit of the waste disposer may control the supply of fluid to the waste disposer during operation of the waste disposer. A nozzle located remote from the waste disposer may also be plumbed to the pump of the waste disposer.

The appliance may also include an internal fire suppressing system. This may deliver a fire retardant substance such as a fire retarding powder or gas or a fluid. In one embodiment the fire retardant substance may be water and capabilities of the appliance may be used for its delivery.

A fire retardant system may combine one or more appliances as described above and one or more fire sensors that supply fire detection signals to a control circuit of an appliance when a fire hazard is detected.

In a distributed system a remote control system may communicate with one or more appliance(s) and send a fire detection signal in response to conditions external to a building in which the one or more appliances are housed.

According to another aspect there is provided a waste disposer including a controllable fluid inlet valve and a control circuit wherein the control circuit controls the controllable inlet valve to introduce fluid into the waste disposer when it is operated.

According to a further aspect there is provided an appliance capable of retarding a fire external to the appliance including:
a. a pump having a pump inlet connectable to a fluid supply and a pump outlet;
b. a nozzle positioned so as to generate a mist external to the appliance when supplied with pressurised fluid from the pump outlet; and
c. a control circuit for controlling the pump to operate when a fire hazard is detected.

According to a further aspect there is provided an appliance capable of retarding a fire external to the appliance including:
a. a pump having a pump inlet connectable to a fluid supply and a pump outlet;
b. a nozzle conduit for supplying pressurised fluid from the pump outlet to an external nozzle positioned so as to generate a mist external to the appliance when in use; and
c. a control circuit for controlling the pump to operate when a fire hazard is detected.

According to a further aspect there is provided an appliance capable of retarding a fire external to the appliance including:
a. a pump having a pump inlet connectable to a fluid supply and a pump outlet;
b. a nozzle positioned so as to generate a mist external to the appliance when in use;
c. a valve for selectively connecting the pump outlet to the nozzle; and
d. a control circuit for controlling the pump to operate and the valve to connect the pump outlet to the nozzle when a fire hazard is detected.

According to a further aspect there is provided an appliance capable of retarding a fire external to the appliance including:
a. a pump having a pump inlet connectable to a fluid supply and a pump outlet;
b. a nozzle conduit for supplying pressurised fluid from the pump outlet to a nozzle for generating a mist external to the appliance when pressurised fluid is supplied thereto;
c. a valve for selectively connecting the output of the pump outlet to the nozzle outlet; and
d. a control circuit for controlling the pump to operate and the valve to connect the pump outlet to the nozzle conduit when a fire hazard is detected.

According to a further aspect there is provided an appliance capable of delivering a fire retardant to a nozzle for retarding a fire external to the appliance including:
a. a fluid inlet for receiving fluid from a fluid supply;
b. a fluid outlet for delivering fluid to a nozzle for generating a fire retarding fluid mist; and
c. a control circuit for controlling the operation of the appliance and the passage of fluid from the fluid inlet to the fluid outlet when a fire hazard is detected.

### BRIEF DESCRIPTION OF THE DRAWINGS

The accompanying drawings which are incorporated in and constitute part of the specification, illustrate embodiments of the invention and, together with the general description of the invention given above, and the detailed description of embodiments given by way of non-limiting example below, serve to explain the principles of the invention.

FIG. 1 shows a washing appliance incorporating an external fire retarding system;

FIG. 2 shows a washing appliance incorporating a coupling for supplying pressurised fluid to a nozzle;

FIG. 3 shows a washing appliance incorporating a coupling for supplying pressurised fluid to a coupling located on the front panel;

FIG. 4 shows a washing appliance incorporating internal and external fire retarding systems;

FIG. 5 shows a washing appliance incorporating an external fire retarding system utilising a dedicated pump;

FIG. 6 shows a washing appliance incorporating a dedicated pump for supplying pressurised fluid to a nozzle;

FIG. 7 shows a washing appliance incorporating an external fire retarding system according to a further embodiment;

FIG. 8 shows a washing appliance incorporating a coupling for supplying pressurised fluid to a nozzle according to a further embodiment;

FIG. 9 shows a washing appliance incorporating a mains water pressure driven external fire retarding system;

FIG. 10 shows a washing appliance incorporating a coupling for supplying mains pressure water to a nozzle;

FIG. 11 shows a waste disposer incorporating an integrated external fire retarding system;

FIG. 12 shows a side cross-sectional view of the waste disposer shown in FIG. 11 with the nozzle in the retracted position;

FIG. 13 shows a side cross-sectional view of the waste disposer shown in FIG. 11 with the nozzle in the extended position;

FIG. 14 shows a top view of the waste disposer shown in FIG. 11;

FIG. 15 shows a waste disposer incorporating an external fire retarding system including a remotely located nozzle;

FIG. 16 shows a side cross-sectional view of the waste disposer shown in FIG. 15 with the nozzle in the retracted position;

FIG. 17 shows a side cross-sectional view of the waste disposer shown in FIG. 15 with the nozzle in the extended position;

FIG. 18 shows a top view of the waste disposer shown in FIG. 15; and

FIG. 19 shows a distributed fire retardant system.

### DETAILED DESCRIPTION

The invention will be described in relation to a range of exemplary appliances but it will be appreciated that the invention may have application to appliances including dishwashers, clothes washers, waste disposers, coffee making machines, water boilers and other like appliances. Where an appliance incorporates or is connected to a water supply this may be advantageously employed for external fire retarding. Likewise a control circuit of an appliance may advantageously be employed to control an external fire retarding system. In the following drawings like integers will be given the same number.

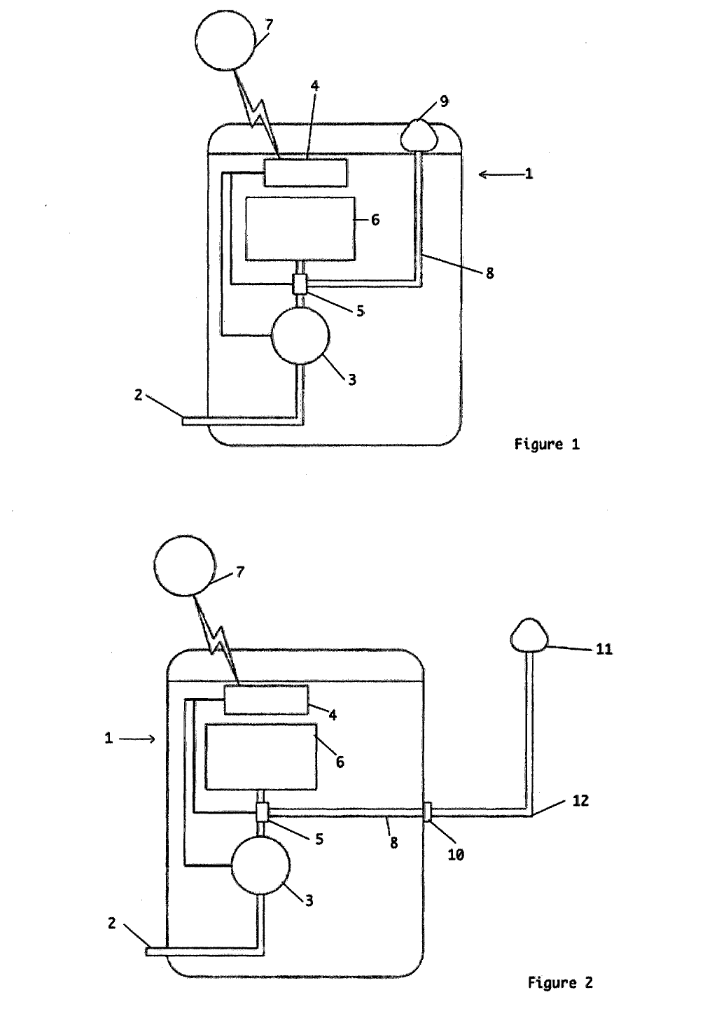

Referring to FIG. 1 there is shown an appliance 1 having a fluid supply line 2 supplying water to pump 3. In normal operation of the appliance control circuit 4 controls pump 3 and multi-port valve 5 to supply pressurised fluid to washing compartment 6.

A fire sensor 7 transmits a fire detection signal when it detects a fire condition. The fire sensor may be wired to a mains power supply or may be battery powered. Alternatively it may be a unit that plugs in to a power outlet for ease of installation. Alternatively the fire sensor may be integrated into the appliance or be a fire sensor integrated into another appliance.

The fire detection signal may be a wireless signal that may be received by a wireless receiver of control circuit 4. Alternatively the fire detection signal may be a sound signal and control circuit 4 may include a sound receiver that detects a specific fire detection signal. Alternatively the fire detection signal may be sent via a signal sent over the electrical mains supply. This may be particularly suited where the fire sensor receives power from the mains supply. Alternatively the fire sensor may be connected to the control circuit via a communications line.

Upon receipt of a fire detection signal control circuit 4 may actuate pump 3 to supply pressurised fluid and actuate multi-port valve 5 to supply pressurised fluid from the pump outlet to nozzle conduit 8 supplying nozzle 9. Nozzle 9 may be a pop out nozzle that extends when supplied with pressurised fluid. It may be located behind a burst plate so that it is normally covered and extends to open the burst plate when activated. The nozzle may produce a fluid mist that creates a fog within a room to retard any fire within the room.

Referring to FIG. 2 there is shown an appliance 1 that functions as per the appliance shown in FIG. 1 other than as described below. In this case upon receipt of a fire detection signal control circuit 4 may actuate pump 3 to supply pressurised fluid and actuate multi-port valve 5 to supply pressurised fluid from the pump outlet to nozzle conduit 8. In this case a nozzle is not provided within the appliance and nozzle conduit 8 has a outlet coupling 10 (in this case a snap fit coupling, although screw type or other couplings may be employed) enabling an external nozzle 11 to be supplied via conduit 12 having a snap fit coupling at one end engaging with snap fit coupling 10. This enables nozzle 11 to be located at a desired location away from the appliance, such as in a work bench or in an elevated position.

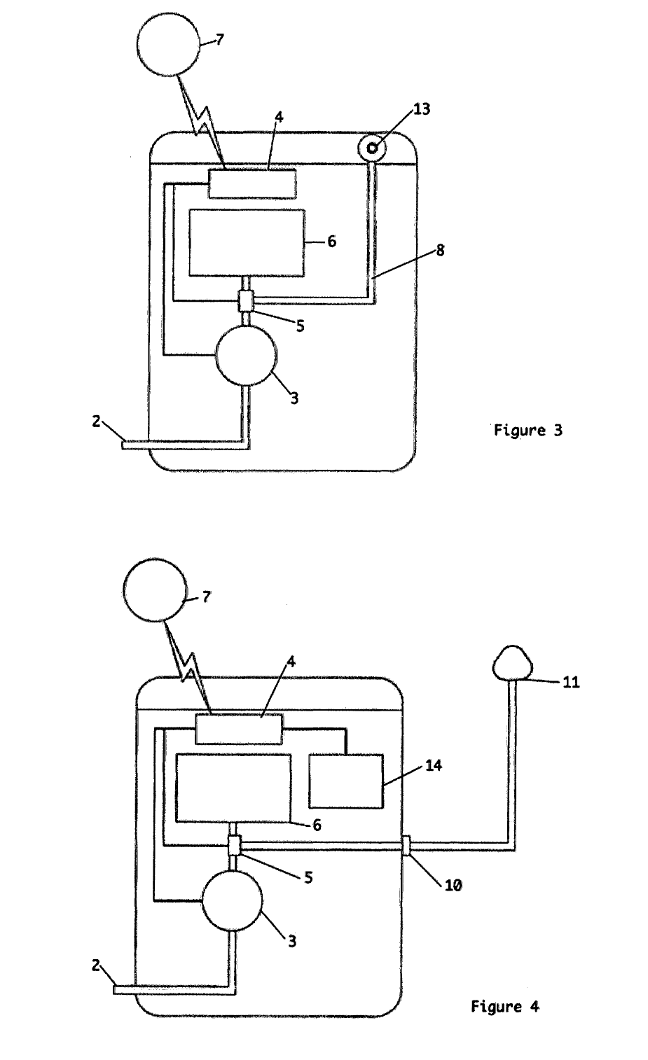

FIG. 3 shows an embodiment similar to FIG. 2 except that the snap fit coupling is provided in the front face of the appliance. This may enable a nozzle to be directly engaged with the snap fit coupling 13 or for the appliance to provide pressurised fluid for use with a cleaning device or to drive an hydraulic driven device.

FIG. 4 shows an embodiment as per the embodiment shown in FIG. 2 except that it includes an internal fire suppression system 14 also. This could be a conventional fire retardant system such as a powder based system suited for electrical fires. Alternatively it could utilise pressurised fluid from the pump to supply an internal nozzle, as per the external fire retardant system. In this case parts of the electrical supply to the appliance may be isolated whilst parts required for internal fire retarding and the associated supply lines may be adequately insulated from fluid.

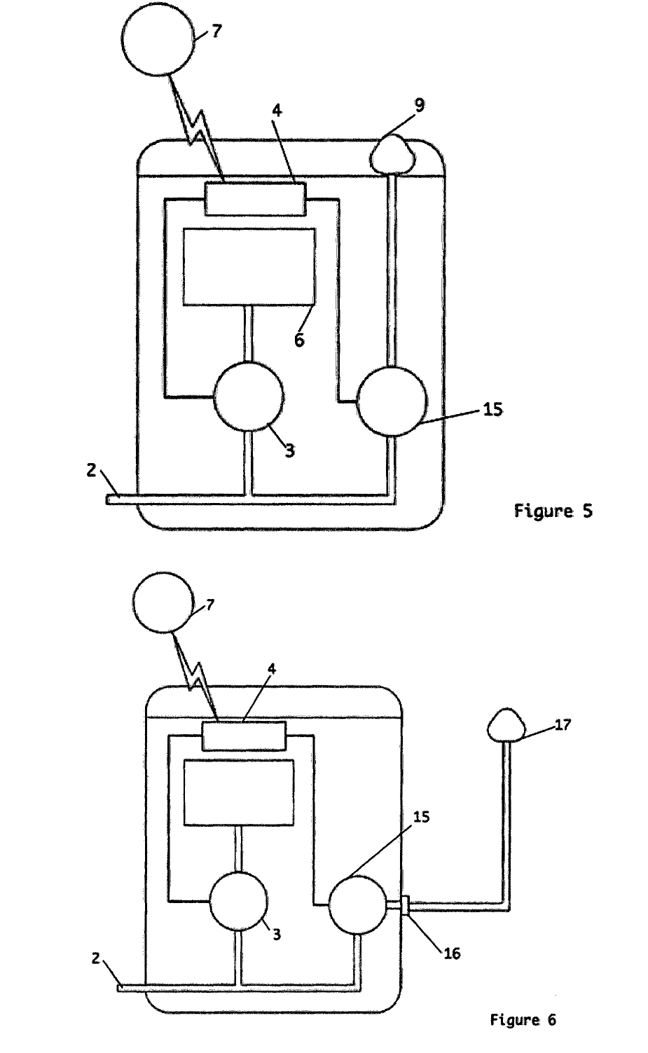

FIG. 5 shows an embodiment as per FIG. 1 except that a dedicated pump 15 is provided to supply pressurised fluid to nozzle 9. This arrangement may be suitable where the appliance pump 3 is not suited for supplying the nozzle or if a dedicated pump may be implemented more cost effectively.

FIG. 6 shows an embodiment as per FIG. 5 except that the outlet from pump 15 is connected to snap fit coupling 16 to enable an external nozzle 17 to be connected.

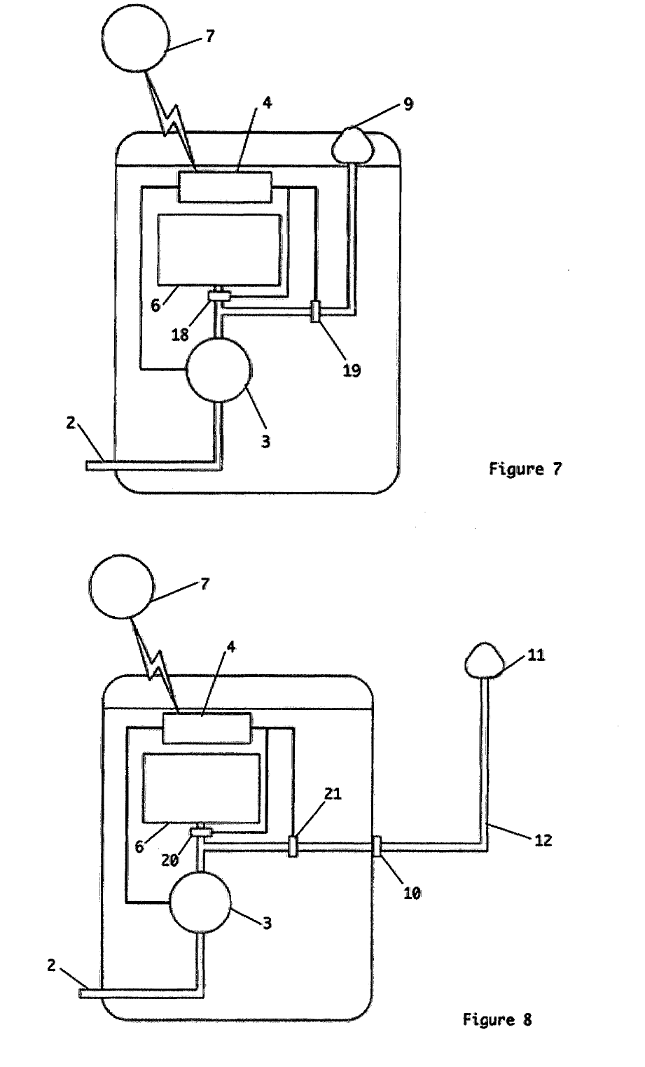

FIG. 7 shows a variant of the appliance shown in FIG. 1 in which the multiport valve 5 is replaced by solenoid valves 18 and 19. Solenoid valve 18 is normally open during normal appliance operation and solenoid valve 19 is open when a fire detection signal is received. Likewise FIG. 8 shows a variant of the design shown in FIG. 2 where multiport valve 5 is replaced with solenoid valves 20 and 21.

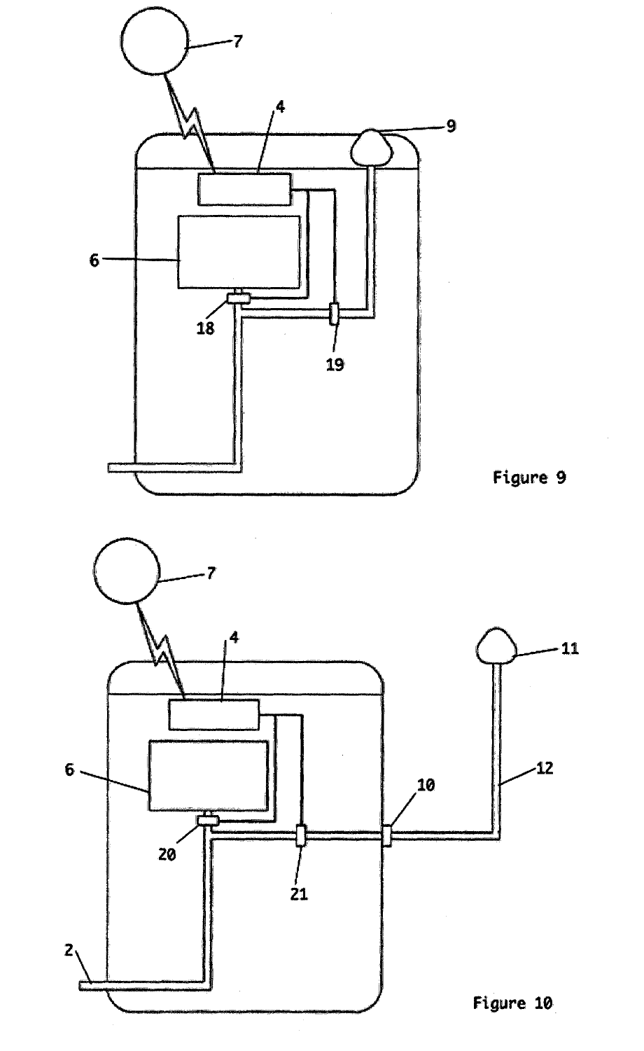

FIG. 9 shows a variant of the arrangement shown in FIG. 7 in which pump 3 is omitted. Where an appliance does not include a pump and the mains pressure is sufficient to cause nozzle 9 to produce a fluid mist this arrangement may be simple and inexpensive. Likewise FIG. 10 shows a variant of the embodiment shown in FIG. 8 where pump 3 is omitted.

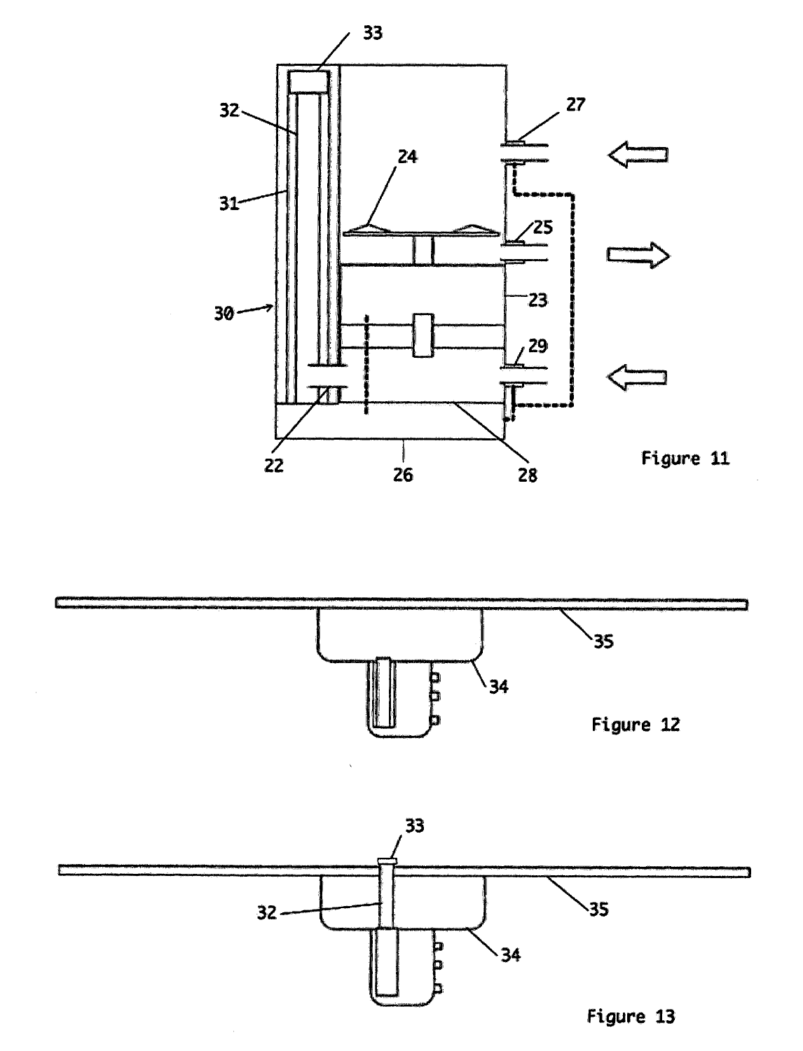

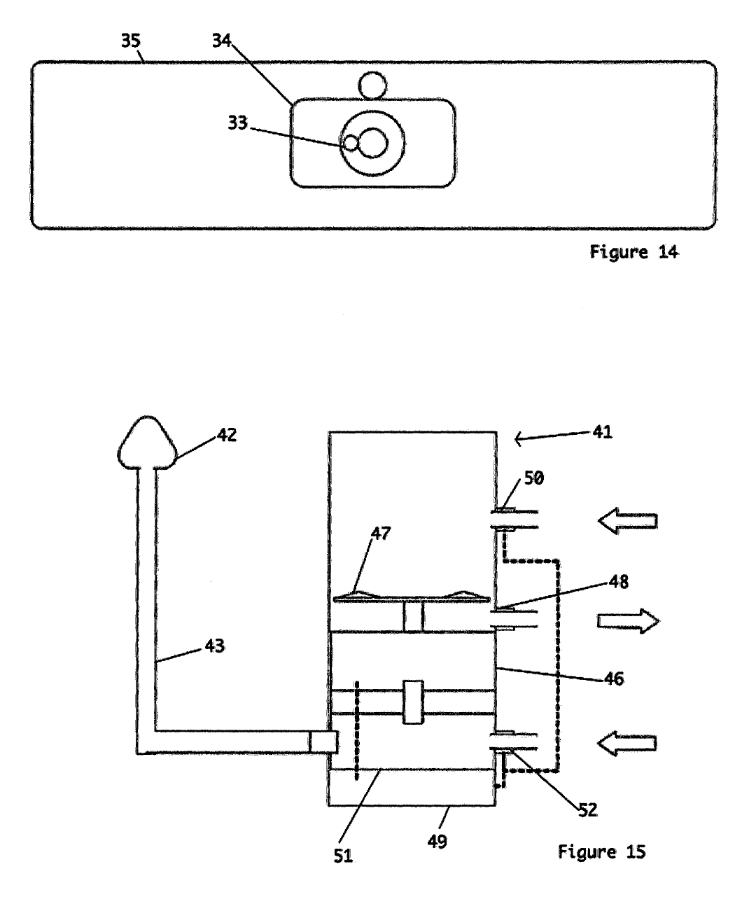

FIG. 12 shows a waste disposer unit including an external fire retardant system installed in a sink 34 of a work bench 35). The waste disposer is shown in FIG. 11 and includes a motor 23 drives macerating blade 24 to comminute material fed in to the waste disposer which is output via port 25. The waste disposer could simply be activated when turned on with a user running water at the same time. Alternatively control circuit 26 may drive solenoid valve 27 to supply water from a water supply to the waste disposer when the motor 23 is running. This may avoid the need to turn on a tap as the waste disposer is operated. A sensor may also be provided to automatically operate the motor and solenoid 27 when material is sensed within the waste disposer.

Motor 23 may also drive pump 28 which receives fluid when solenoid valve 29 is opened by control circuit 26. Pressurised fluid output from pump 28 may be supplied via conduit 22 to pop up nozzle arrangement 30. Pop up nozzle 30 include an outer chamber 31 and inner tube 32 which supplies pressurised fluid to nozzle 33. When control circuit 26 receives a fire detection signal from a fire sensor it may drive motor 23 and open solenoid valve 29. The pressurised fluid supplied to pop up nozzle 30 causes inner tube 32 to rise (as shown in FIG. 13) when supplied with pressurised fluid.

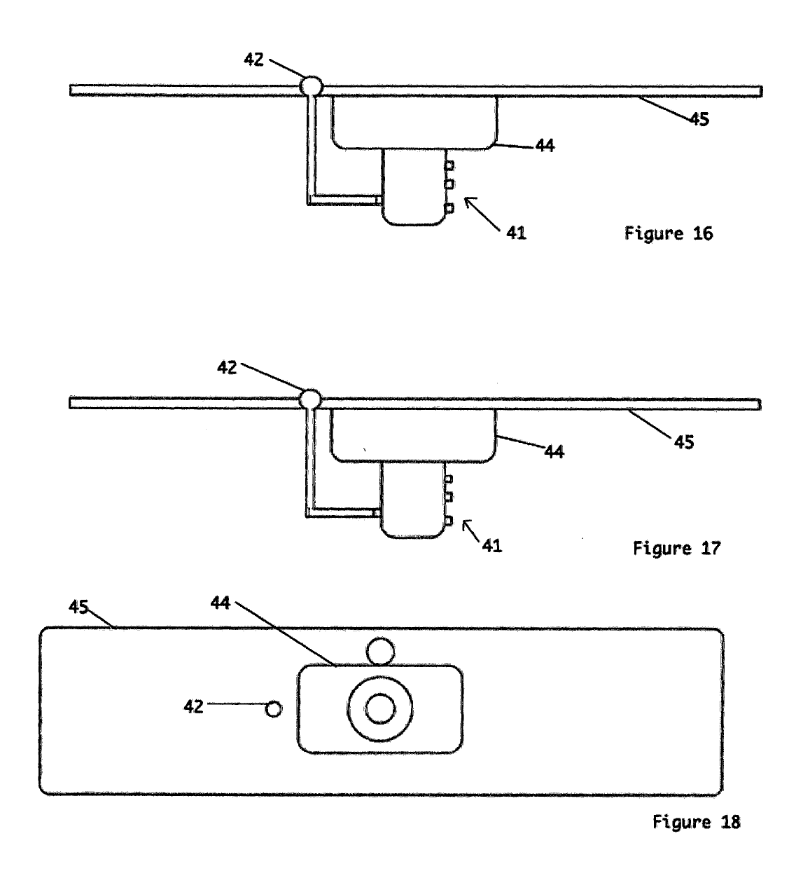

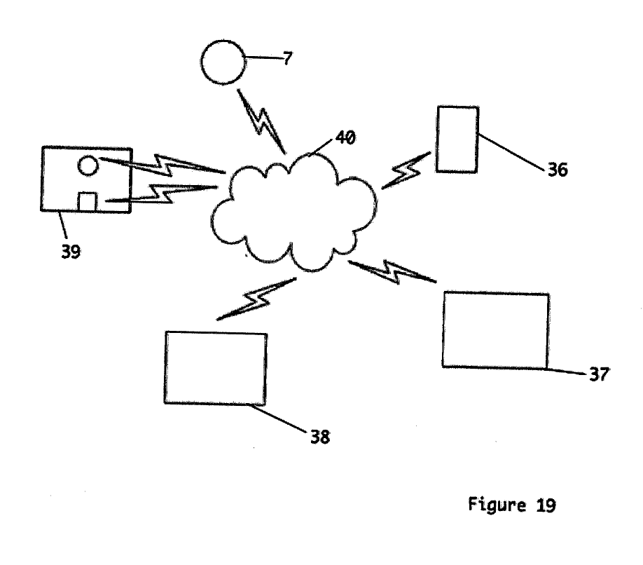

FIG. 15 shows a waste disposer unit 41 for providing pressurised fluid to an external nozzle 42 via conduit 43. As shown in FIGS. 16 to 18 the waste disposer 41 may be installed in a sink 44 in a kitchen bench 45 with the nozzle 42 also installed in the bench 45. As in the previous embodiment motor 46 drives macerating blade 47 to comminute material fed in to the waste disposer which is output via port 48. Again, the waste disposer could simply be activated when turned on with a user running water at the same time. Alternatively control circuit 49 may drive solenoid valve 50 to supply water from a water supply to the waste disposer when the motor 46 is running. This may avoid the need to turn on a tap as the waste disposer is operated. A sensor may also be provided to automatically operate the motor 46 and solenoid 50 when material is sensed within the waste disposer.

Motor 46 may also drive pump 51 which receives fluid when solenoid valve 52 is opened by control circuit 49. Pressurised fluid output from pump 51 may be supplied via conduit 43 to pop up nozzle 42 in bench 45. When control circuit 49 receives a fire detection signal from a fire sensor it may drive motor 46 and open solenoid valve 52. The pressurised fluid supplied to pop up nozzle 42 causes it to rise when supplied with pressurised fluid. Whilst a pop up nozzle is shown it will be appreciated that a fixed nozzle may also be employed. Further, the nozzle could be located in a different position such as the front of the bench, on a wall, in the ceiling etc.

FIG. 19 shows a schematic diagram of a distributed system in which a fire sensor 7 is in communication with appliances 37 to 39 via a communications network 40. This system could be within several rooms of one building or distributed over a number of buildings. Appliance 39 includes an internal sensor and may send a fire detection signal to other appliances when a fire is detected. Such a system may include a central control centre 36 that may send a fire detection signal to all appliances when a-fire event such as a bush fire is detected. In this way one sensor may activate the external fire retarding systems of multiple appliances within one building or many buildings.

There is thus provided an appliance having an external fire retarding capability utilising the fluid supply system and or control system of an appliance. This results in a compact an economical solution with a range of possible implementations. An internal fire retarding system may also be provided utilising functionality of the external fire retarding system. There is also provided a fire retarding system allowing multiple appliances with fire retarding capability and multiple sensors to provide an integrated solution for multiple locations.

While the present invention has been illustrated by the description of the embodiments thereof, and while the embodiments have been described in detail, it is not the intention of the Applicant to restrict or in any way limit the scope of the appended claims to such detail. Additional advantages and modifications will readily appear to those skilled in the art. Therefore, the invention in its broader aspects is not limited to the specific details, representative apparatus and methods, and illustrative examples shown and described. Accordingly, departures may be made from such details without departure from the spirit or scope of the Applicant's general inventive concept.

1. An appliance having capability to assist in retarding a fire external to the appliance including:
a. a pump having a pump inlet connectable to a fluid supply and a pump outlet;
b. a nozzle conduit for supplying pressurised fluid from the pump outlet to a nozzle positioned so as to generate a mist external to the appliance when supplied with pressurised fluid; and
c. a control circuit which operates in a fire hazard mode to control the pump to operate when a fire hazard is detected.

2. An appliance as claimed in claim 1 wherein the pump is utilised for the normal appliance function as well as for supplying pressurised fluid to the nozzle conduit.

3. An appliance as claimed in claim 2 including a flow control arrangement which normally connects the pump outlet to the normal appliance function and connects the pump outlet to the nozzle conduit when a fire hazard is detected.

4. An appliance as claimed in claim 3 wherein the flow control arrangement is a multi-port valve.

5. An appliance as claimed in claim 3 wherein the flow control arrangement includes a plurality of solenoid valves.

6. An appliance as claimed in claim 1 wherein the pump is a dedicated pump for supplying pressurised fluid to the nozzle conduit.

7. An appliance as claimed in claim 1 wherein the nozzle conduit is connected to an outlet coupling enabling an external nozzle to be connected thereto.

8. An appliance as claimed in claim 7 wherein the outlet coupling is a snap fit connector.

9. An appliance as claimed in claim 1 including a nozzle connected to the outlet coupling.

10. An appliance as claimed in claim 9 wherein the nozzle is provided on a surface on an appliance that is exposed when the appliance is installed.

11. An appliance as claimed in claim 9 wherein the nozzle is a pop-out nozzle.

12. An appliance as claimed in claim 11 wherein the exposed face includes a burst panel that is removed when the nozzle is activated.

13. An appliance as claimed in claim 1 wherein the control circuit controls the normal appliance function and operation in the fire hazard mode.

14. An appliance as claimed in claim 1 wherein the control circuit is responsive to a fire detection sensor in the appliance to operate in the fire hazard mode.

15. An appliance as claimed in claim 1 wherein the control circuit is responsive to an external fire detection signal supplied to the control circuit to operate in the fire hazard mode.

16. An appliance as claimed in claim 15 wherein the signal is a wireless signal from a remote fire sensor.

17. (canceled)

18. (canceled)

19. (canceled)

20. (canceled)

21. (canceled)

22. (canceled)

23. An appliance as claimed in claim 1 wherein the appliance is a waste disposer.

24. An appliance as claimed in claim 23 including a pump driven by a motor of the waste disposer.

25. An appliance as claimed in claim 24 including a fluid inlet for supplying fluid to the pump.

26. An appliance as claimed in claim 23 including a popup nozzle that extends out of the waste disposer when pressurised fluid is provided thereto.

27. An appliance as claimed in claim 23 wherein the control circuit controls the supply of fluid to the waste disposer during operation of the waste disposer.

28. (canceled)

29. (canceled)

30. An appliance as claimed in claim 1 including an internal fire suppressing system.

31. An appliance as claimed in claim 30 wherein the internal fire suppressing system creates a fluid mist within the appliance when a fire is detected within the appliance.

32. A fire retardant system comprising an appliance as claimed in claim 1 and a fire sensor that supplies a fire detection signal to the control circuit when a fire hazard is detected.

33. (canceled)

34. (canceled)

35. (canceled)

36. A waste disposer including a controllable fluid inlet valve and a control circuit wherein the control circuit controls the controllable inlet valve to introduce fluid into the waste disposer when it is operated.

37. An appliance capable of retarding a fire external to the appliance including:
a. a pump having a pump inlet connectable to a fluid supply and a pump outlet;
b. a nozzle positioned so as to generate a mist external to the appliance when supplied with pressurised fluid from the pump outlet; and
c. a control circuit for controlling the pump to operate when a fire hazard is detected.

38. (canceled)

39. (canceled)

40. (canceled)

41. (canceled)
